(19) United States
(12) Patent Application Publication
(10) Pub. No.: US 2007/0019753 A1
(43) Pub. Date: Jan. 25, 2007

(54) Adaptive multilevel block coded modulation for OFDM systems

(75) Inventor: Kyeong Jin Kim, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/491,298

(22) Filed: Jul. 20, 2006

Related U.S. Application Data
(60) Provisional application No. 60/701,230, filed on Jul. 20, 2005.

(51) Int. Cl. H04K 1/10

(52) U.S. Cl. 375/260

(57) ABSTRACT

A method includes grouping a data stream into a first plurality of subgroups, modulating a plurality of subcarriers with the first plurality of subgroups, adaptively applying a block code to said data stream comprising a repetition code, a Hamming code, and a plurality of uncoded bits based upon a channel characteristic of each of said plurality of subcarriers, and transmitting the data stream on the plurality of subcarriers.

### CROSS REFERENCE TO RELATED APPLICATION

This Application claims the benefit under 35 USC 119(e) of U.S. Provisional Application No. 60/701,230 filed Jul. 20, 2005.

### TECHNICAL FIELD

The exemplary and non-limiting embodiments of the invention relate generally to wireless transmissions systems, in particular systems using Frequency Division Multiplexing with a number of sub-carriers.

### BACKGROUND OF THE INVENTION

Wireless communications systems routinely use various schemes to compensate for signal interference and fading. A popular approach is the use of Orthogonal Frequency Division Multiplexing (OFDM), in which several sub-carriers are used and modulated in different fashions so that the receiver can combine the results of several channels to calculate the true value of a transmitted symbol. With a coding into an expanded set of signals, power and bandwidth efficient communications can be achieved. Coded modulation can be categorized, generally, into trellis coded modulation (TCM) and block coded modulation (BCM). There has been described, for example in “A new multilevel coding method using error-correcting code,” by H. Imai, S. Hirakawa, IEEE Trans. on Inform. Theory, vol. IT-23, pp. 371-377, 1977, the foundation for multistage decoding for multi-level ML-BCM. Furthermore, there has been described a method to combine the block coding with a modulation (BCM). The principle of the BCM is to make a set partitioning of the signal constellation and assign a binary code to each level of partition. The minimum distance within each level of partition increases down the partition tree.

It has been shown that the optimum codes for Gaussian channels are not always efficient on fading channels. Minimum squared Euclidean distance is the factor that approximately determines the bit error rate (BER) performance of a coded modulation over a Gaussian channel. Using the product distance, defined as dₚ²=d_{E}²d_{H}, where d_{H} is the Hamming distance and d_{E} is the minimum Euclidean distance, some design rules have been proposed. The most efficient rule, the balanced distance design rule, is proposed to make the product distances on partition levels as close as possible. Since the sets with the smallest minimum distance dominate the bit error rate, in the BCM approach, block codes the same length, with different Hamming distances, are used to encode input bits.

In such a coded system, the powerful code having the largest. Hamming distance is used to select signal points that are closest together, so that errors that would otherwise result from the close distance are compensated by the code.

Thus, the multilevel BCM allows one to construct bandwidth efficient block coded modulations with a large product distance from the block component codes and the modulation. Using the balanced distance design rule, one can obtain an asymptotic coding gain.

Orthogonal frequency division multiplexing (OFDM) may be used to mitigate the effects of frequency selective fading by forming a set of carriers, where each of these subcarriers exhibits flat fading. As a result of this property, a simple zero-forcing equalizer can be employed. However there exists a noise enhancement depending on the magnitude of an estimated channel. In addition, the performance of such an equalizer is dominated by the weak subcarriers.

### SUMMARY

The foregoing and other problems are overcome, and other advantages are realized, in accordance with the exemplary embodiments of these teachings.

In accordance with an exemplary embodiment of the invention, a method includes grouping a data stream into a first plurality of subgroups, modulating a plurality of subcarriers with the first plurality of subgroups, adaptively applying a block code to the data stream comprising a repetition code, a Hamming code, and a plurality of uncoded bits based upon a channel characteristic of each of the plurality of subcarriers, and transmitting the data stream on the plurality of subcarriers.

In accordance with another exemplary embodiment of the invention, a program of machine-readable instructions, tangibly embodied on an information bearing medium and executable by a digital data processor, performs actions including grouping a data stream into a first plurality of subgroups, modulating a plurality of subcarriers with the first plurality of subgroups, adaptively applying a block code to the data-stream comprising a repetition code, a Hamming code, and a plurality of uncoded bits based upon a channel characteristic of each of the plurality of subcarriers, and transmitting the data stream on the plurality of subcarriers.

In accordance with another exemplary embodiment of the invention, a mobile station includes a transmitter, a processor coupled to the transceiver and a memory coupled to the processor for storing a set of instructions, executable by the processor, for grouping a data stream into a first plurality of subgroups, modulating a plurality of subcarriers with the first plurality of subgroups, applying a block code to the data stream comprising a repetition code, a Hamming code, and a plurality of uncoded bits, and transmitting the data stream on the plurality of subcarriers via the transceiver.

In accordance with another exemplary embodiment of the invention, a method includes receiving a data stream on a plurality of subcarriers modulated by a plurality of subgroups into which the data stream is grouped the data stream adaptively encoded with a block code comprising a repetition code, a Hamming code, and a plurality of uncoded bits based upon a channel characteristic of each of the plurality of subcarriers, decoding the data stream, and demodulating the data stream.

In accordance with another exemplary embodiment of the invention, an encoder includes an element for receiving a data stream modulated by a plurality of subgroups into which the data stream is grouped and an element for adaptively applying a block code to the data stream comprising a repetition code, a Hamming code, and a plurality of uncoded bits based upon a channel characteristic of each of a plurality of subcarriers.

In accordance with another exemplary embodiment of the invention, a decoder includes an element for receiving a data stream adaptively encoded with a block code comprising a repetition code, a Hamming code, and a plurality of uncoded bits based upon a channel characteristic of each of a plurality of subcarriers, and an element for decoding the data stream.

In accordance with another exemplary embodiment of the invention, a user equipment includes a receiver, a processor coupled to the receiver, and a memory coupled to the processor for storing a set of instructions, executable by the processor, for receiving a data stream modulated by a plurality of subgroups into which the data stream is grouped the data stream adaptively encoded with a block code including a repetition code, a Hamming code, and a plurality of uncoded bits based upon a channel characteristic of each of a plurality of subcarriers, decoding the data stream, and demodulating the data stream.

In accordance with another exemplary embodiment of the invention, a system includes a network element comprising a transmitter, a processor coupled to the transmitter, and a memory coupled to the processor for storing a set of instructions, executable by the processor, for grouping a data stream into a first plurality of subgroups, modulating a plurality of subcarriers with the first plurality of subgroups, adaptively applying a block code to the data stream including a repetition code, a Hamming code, and a plurality of uncoded bits based upon a channel characteristic of each of the plurality of subcarriers, and transmitting the data stream on the plurality of subcarriers via the transmitter, and a user equipment in communication with the network element including a receiver, a processor coupled to the receiver; and a memory coupled to the processor for storing a set of instructions, executable by the processor, for receiving the data stream, decoding the data stream, and demodulating the data stream.

In accordance with another exemplary embodiment of the invention, an integrated circuit includes first circuitry having an input operable to receive a data stream and to group the data stream into a first plurality of subgroups, second circuitry operable to modulate a plurality of subcarriers with the first plurality of subgroups, and third circuitry operable to adaptively apply a block code to the data stream comprising a repetition code, a Hamming code, and a plurality of uncoded bits based upon a channel characteristic of each of the plurality of subcarriers.

### BRIEF DESCRIPTION OF THE DRAWING

FIG. 1 shows a block diagram of a multilevel block code for the 8-PSK according to an exemplary embodiment of the invention.

FIG. 2 shows the partitioning tree for the 8-PSK of FIG. 1 according to an exemplary embodiment of the invention.

FIG. 3 shows a block diagram for a ML-DCM based on the RHP component codes according to an exemplary embodiment of the invention.

FIG. 4 shows the partitioning tree for the RHPU scheme according to an exemplary embodiment of the invention.

FIG. 5 shows the partitioning tree for the RHPUU scheme according to an exemplary embodiment of the invention.

FIG. 6 shows the trellis diagram for the RHP scheme of FIG. 3 according to an exemplary embodiment of the invention.

FIG. 7 shows the block diagram for the ML-BCM based on the 24D-RHH component codes according to an exemplary embodiment of the invention.

FIG. 8 shows the trellis diagram for the 16D RHHuuu scheme according to an exemplary embodiment of the invention.

FIG. 9 shows the trellis diagram for the 14D RHHuuu scheme according to an exemplary embodiment of the invention.

FIG. 10 shows the trellis diagram for an RHP scheme according to an exemplary embodiment of the invention.

FIGS. 11 and 12 show a comparison of BER performance for numerous exemplary embodiments of the invention.

FIGS. 13 and 14 show frequency dependence and code allocation for numerous exemplary and non-limiting embodiments of the invention.

FIGS. 15-17 show a comparison of BER and PER performance for numerous exemplary embodiments of the invention.

FIG. 18 is a block diagram of an apparatus suitable for implementing exemplary embodiments of the invention.

FIG. 19 is a flow chart of a method according to an exemplary and non-limiting embodiment of the invention.

FIG. 20 is a flow chart of a method according to an exemplary and non-limiting embodiment of the invention.

### DETAILED DESCRIPTION

Exemplary and non-limiting embodiments of the invention provide a method of coding in an OFDM scheme, in which the signal constellation is partitioned into a set of subcarriers that are modulated with a block coding structure composed of a repetition code, a variable length Hamming code and a set of uncoded (spare) bits. Exemplary embodiments of the invention teach adaptively changing the modulation of subcarriers in response to changing channel conditions. Further exemplary embodiments of the invention teach increasing the code rate for subcarriers with higher signal gains and decreasing the code rate for subcarriers with lower signal gains as well as selecting the lower level codes in order to maximize product distance.

In general, having an exact knowledge of a channel at a transmitter allows one to optimally, or nearly optimally, adapt the rate and the power given the average transmit power constraint. Specifically, each subcarrier can be modulated with a different modulation scheme in accordance with its power strength thereby providing an adaptive modulation. The allocation of bits and the transmit power to each subcarrier may be accomplished using a bit loading algorithm.

With these facts in mind, exemplary and non-limiting embodiments of the invention provide an efficient coding method that adaptively applies the multilevel block coding depending on the channel characteristics for each subcarrier. Using this adaptive scheme, exemplary embodiments of the invention provide a variable rate ML-BCM system as described below.

The encoder matrix gives provides a code mapping for inputs where each row of the encoder matrix directly corresponds to a binary codeword. Let d_{E}ⁱ be the minimum distance in the i-th level. With the set partitioning according to exemplary embodiments of the invention, one obtains the following inequality down the partition tree
d_{E}⁰≦d_{E}¹≦. . . ≦d_{E}^{L}.

The partition level Lᵢ is then encoded with a binary code, Cᵢ. If Cᵢ is an (nᵢ, kᵢ, d_{H}ⁱ) block code with the Hamming distance d_{H}ⁱ, the minimum product distance is

$${d}_{p , min}^{2} ≡ {min}_{i = 1 , 2 , … , L} \{ {( {d}_{E}^{i} )}^{2} {d}_{H}^{i} \} , and the coding rate is R = \frac{{\sum }_{i = 1}^{L} {k}_{i}}{{\sum }_{k = 1}^{L} {n}_{i}} .$$

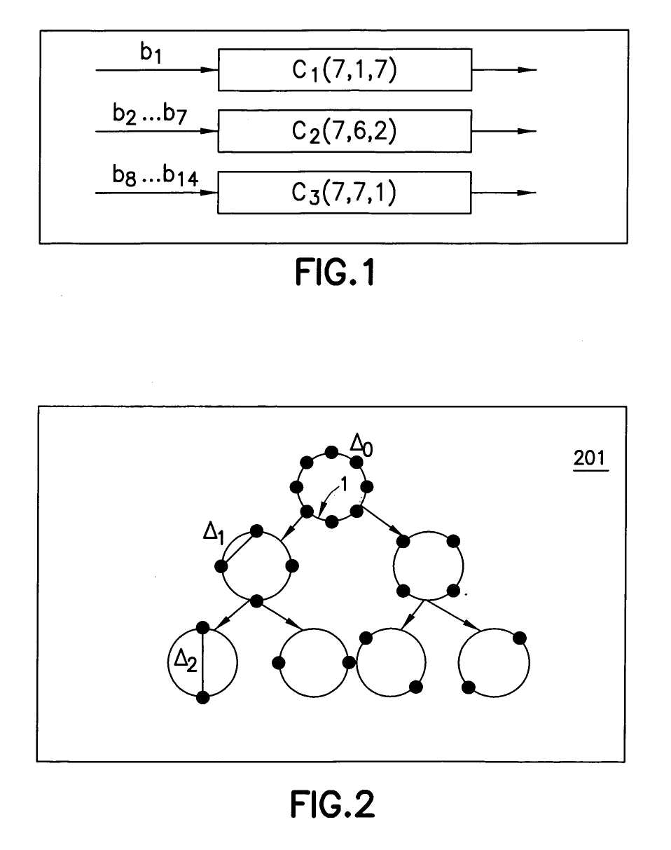

With reference to FIG. 1, there is illustrated an example utilizing a block of 14 input bits. As illustrated, the input bits are sent in the seven modulation time intervals, so that two bits are sent per modulation interval. For the following encoder matrix,

$${E}_{1} = [ \begin{matrix}{b}_{1} & {b}_{1} & {b}_{1} & {b}_{1} & {b}_{1} & {b}_{1} & {b}_{1} \\ {b}_{2} & {b}_{3} & {b}_{4} & {b}_{5} & {b}_{6} & {b}_{7} & P \\ {b}_{8} & {b}_{9} & {b}_{10} & {b}_{11} & {b}_{12} & {b}_{13} & {b}_{14}\end{matrix} ] ,$$

bⱼ, j=1 2, . . . ,14, is an input bit, P is a parity-bit with the parity condition P=b₂⊕b₃⊕b₄⊕b₅⊕b₆⊕b₇, where ⊕ denotes the bit-by-bit (modulo 2) operation. The 8-PSK modulation requires three partition levels, i.e., three rows in the encoder matrix. The first row is the repetition code, denoted by Cᵢ(7,1,7), the second row is the parity code, C₂(7,6,2), and the last row is C₃(7,7,1). The seven columns are read out one-by-one, mapped to the signal set, and the corresponding seven symbols are transmitted. It can be shown that the bandwidth efficiency for this coded system is 2 bit/symbol/Hz. The corresponding set partitioning is shown with reference to FIG. 2 wherein there is illustrated the partitioning tree 201 for the exemplary 8-PSK. Following is a demonstration of an exemplary embodiment of the BCM based on the 8PSK. An asymptotic coding gain can be realized as follows. If two codes are different in the first row of the encoder matrix, E₁, then all seven bits should be different, as shown in the following two matrices, in which the first rows are opposite and the second and third rows are identical.

$$[ \begin{matrix}0 & 0 & 0 & 0 & 0 & 0 & 0 \\ 0 & 1 & 1 & 1 & 1 & 0 & 0 \\ 1 & 0 & 1 & 1 & 0 & 1 & 1\end{matrix} ] : [ \begin{matrix}1 & 1 & 1 & 1 & 1 & 1 & 1 \\ 0 & 1 & 1 & 1 & 1 & 0 & 0 \\ 1 & 0 & 1 & 1 & 0 & 1 & 1\end{matrix} ] .$$

Thus, the total squared Euclidean distance is 7Δ₀², where Δ₀ is the Euclidean distance at the first level. If they differ in one position-in the second row, then the parity bit has to be different to satisfy the parity condition, such that the codes-are separated by Δ₁ in two positions, giving the total squared Euclidean distance 2Δ₁². One of the examples for this case is given in the following, where the third place in the second row is different.

$$[ \begin{matrix}0 & 0 & 0 & 0 & 0 & 0 & 0 \\ 0 & 1 & 1 & 1 & 1 & 0 & 0 \\ 1 & 0 & 1 & 1 & 0 & 1 & 1\end{matrix} ] : [ \begin{matrix}0 & 0 & 0 & 0 & 0 & 0 & 0 \\ 0 & 1 & 0 & 1 & 1 & 0 & 0 \\ 1 & 0 & 1 & 1 & 0 & 1 & 1\end{matrix} ] .$$

Also, the total squared Euclidean distance in the third row is A₂², where one of the input bits is different in the third row of the encoder matrix E₁ as

$$[ \begin{matrix}0 & 0 & 0 & 0 & 0 & 0 & 0 \\ 0 & 1 & 1 & 1 & 1 & 0 & 0 \\ 1 & 0 & 1 & 1 & 0 & 1 & 1\end{matrix} ] : [ \begin{matrix}0 & 0 & 0 & 0 & 0 & 0 & 0 \\ 0 & 1 & 1 & 1 & 1 & 0 & 0 \\ 1 & 0 & 1 & 1 & 0 & 1 & 0\end{matrix} ] .$$

Since the overall minimum total squared Euclidean distance, defined as the product distance, is d_{p,min}²=4, 3-dB asymptotical coding gain over the QPSK is achieved.

For a set of received signals {r(n),n=1, 2, . . . , 12}, one can apply the maximum likelihood sequence detection (MLSD). However, the number of states for a trellis is 2¹³=8,192, with b^{Δ}=Σᵢ₌₁⁴(nᵢ−kᵢ)=13, so that it is impractical for a Leech lattice based BCM. As a result, existing algorithms, such as that disclosed in “Fast Decoding of the Leech Lattice,”, IEEE J. on Select Areas in Commun., vol. 7, pp. 959-966, August 1989, by Y. Be'ery, B. Shahar, and J. Snyders. For this reason, exemplary embodiments of the invention can employ the detection and decoding algorithm described as follows.

The decoding process is divided into two parallel decoding processes since the Leech lattice based BCM consists of two half Leech lattice decoders H₂₄. The final decision is made by selecting the better one from two results of H₂₄ decoders. The H₂₄ decoder is the Golay decoder with parity constraints. For a set of received signals {r(n),n=1, 2, . . . , 12}, one first computed the Euclidean distance, denoted by dᵢⱼₖ(n), between the representation point and the received signals. To find the cost function associated with the (I,j) indexes, compare dᵢⱼ₀(n) with dᵢⱼ₁(n), choose the smaller one, and assign it as dᵢⱼ(n). That is, dᵢⱼ(n)=min{dᵢⱼ₀(n),dᵢⱼ₁(n)}. For {r(n)}, compute a set of dij(n) and the absolute difference between dᵢⱼ₀(n) and dᵢⱼ₁(n), Δᵢⱼ(n)=|dᵢⱼ₁(n)−dᵢⱼ₀(n)|, for twelve symbol intervals. These differences will be used in parity constraint check block. A single bit error can occur on th k index if one mistakenly chooses dᵢⱼ₀ when dᵢⱼ₁ is the minimum. The parity sign pᵢⱼ(n) is used to record if dᵢⱼ₀ or dᵢⱼ₁ is chosen, i.e.,

$${p}_{ij} ( n ) = \{ \begin{matrix}0 ; & if {d}_{ij} ( n ) = {d}_{ij 0} ( n ) , \\ 1 ; & if {d}_{ij} ( n ) = {d}_{ij 1} ( n ) .\end{matrix}$$

If the modulo 2 summation of pᵢⱼ(n) is different from the overall parity of the codewords,

$$P ( c ) = ⊕ {\sum }_{m = 1}^{12} {p}_{ij} ( n ) ,$$

for

group-A codewords, the overall parity is zero, then an odd numbers of bit errors occurred. Similarly, for group-B codewords, an even number of bit errors happen if the modulo 2 summation of pᵢⱼ(n) is different from the overall parity of the codewords, P9c) . For a single bit error for group-A codewords, one can correct a single bit error with the following approach. With the recorded magnitude difference between dᵢⱼ₀(n) and dᵢⱼ₁(n), the smallest difference tends to be susceptible to channel noise and disturbance, so that a single bit error most likely takes place at the symbol with the smallest difference between dᵢⱼ₁(n) and dᵢⱼ₀(n) . To correct a single error, one needs to flip one of the k indexes, and update the cost function with the corresponding Δ^{min}(C). That is, a best codeword c_{best} is

$${c}_{ best} = arg {min}_{ c ∈ {2}^{ 12}} ( {\sum }_{m = 1}^{ 12} {d}_{ ij} ( n ) + {Δ}^{ min} ( c ) P ( c ) ) ,$$

Where Δ^{min}(C)=min(Δᵢⱼ(n),n=1,2, . . . ,12}. The 12(I,j) indexes are the entries of c_{best} and the k indexes are given by pᵢⱼ(n),n=1,2, . . . ,12, except one index which contributed Δ^{min}(C).

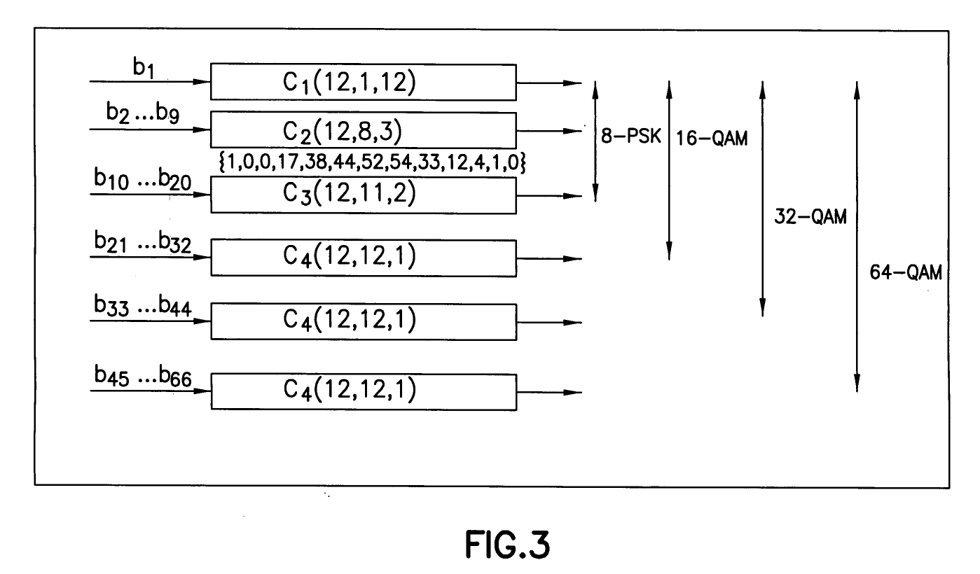

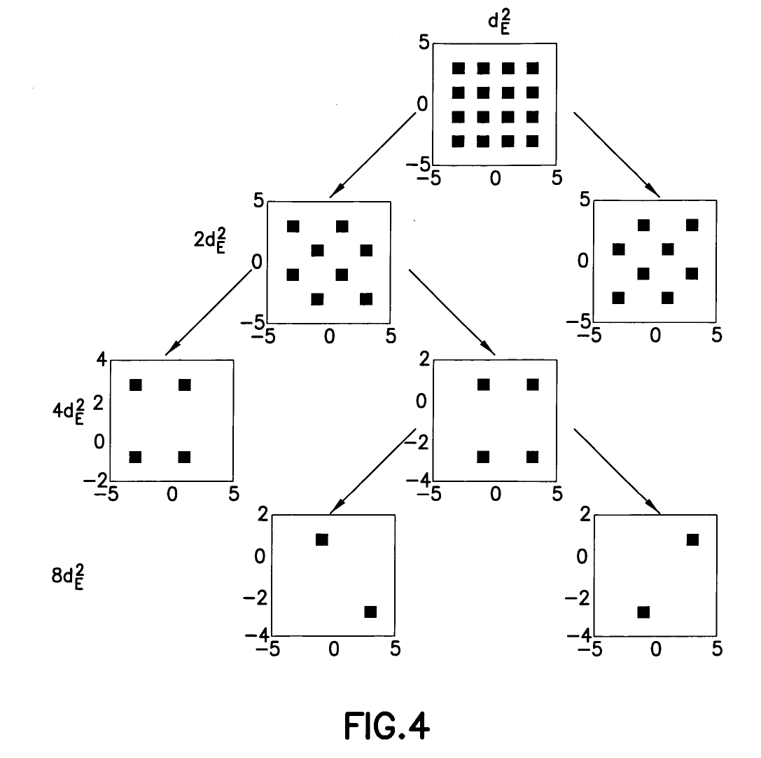

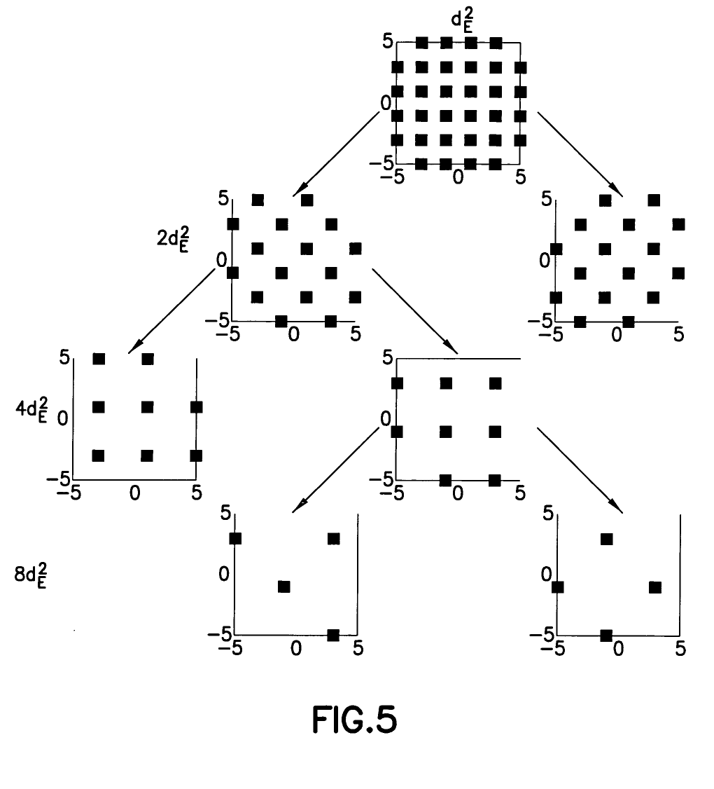

The block diagram for a 24D RHPuuu is shown in FIG. 3. This structure is composed of three component codes such as C₁(12,1,12), a repetition code, C₂(12,8,3), a shortened Hamming code with the weight distribution w={1,0,0,17,38,44,52,54,33,12,4,1,0} and C₃(12,11,2), a parity check code. Depending on the number of uncoded bits, one can change the signal constellation, 8PSK/16QAM/32QAM/64QAM, and the coding rate, 0.555/0.666/0.777. The coding rate is variable with a different number of uncoded bits. The corresponding bandwidth efficiency is 1.6666/2.6666/3.6666/4.6666 [bits/symbol/Hz]. FIG. 4 and FIG. 5 illustrate an exemplary partitioning level for the 16-QAM and 32-QAM, respectively. One can readily apply a similar approach to the 64-QAM.

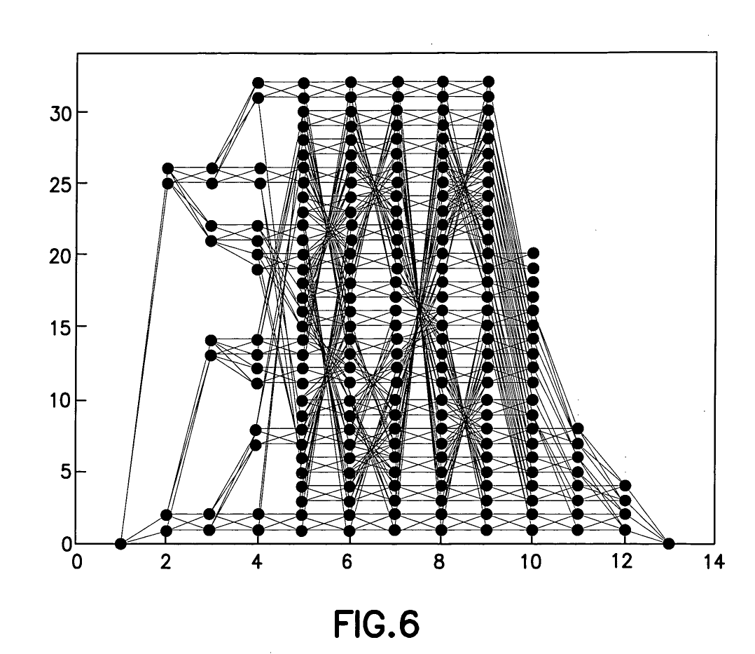

Half of the trellis diagram of the group-A for the scheme illustrated in FIG. 3 is illustrated in FIG. 6. Note that the number of states is 32 and the number of parallel branches is 1/2/3/4 depending on the 8PSK/16QAM/32QAM/64QAM subcarrier modulation. The encoder matrices are

$${E}_{24 D - RHP} = [ \begin{matrix}{b}_{1} & {b}_{1} & {b}_{1} & {b}_{1} & {b}_{1} & {b}_{1} & {b}_{1} & {b}_{1} & {b}_{1} & {b}_{1} & {b}_{1} & {b}_{1} \\ {b}_{2} & {b}_{3} & {b}_{4} & {b}_{5} & {b}_{6} & {b}_{7} & {b}_{8} & {b}_{9} & c & c & c & c \\ {b}_{10} & {b}_{11} & {b}_{12} & {b}_{13} & {b}_{14} & {b}_{15} & {b}_{16} & {b}_{17} & {b}_{18} & {b}_{19} & {b}_{20} & P\end{matrix} ] , \\ {E}_{24 D - {RHP}_{u}} = [ \begin{matrix}{b}_{1} & {b}_{1} & {b}_{1} & {b}_{1} & {b}_{1} & {b}_{1} & {b}_{1} & {b}_{1} & {b}_{1} & {b}_{1} & {b}_{1} & {b}_{1} \\ {b}_{2} & {b}_{3} & {b}_{4} & {b}_{5} & {b}_{6} & {b}_{7} & {b}_{8} & {b}_{9} & c & c & c & c \\ {b}_{10} & {b}_{11} & {b}_{12} & {b}_{13} & {b}_{14} & {b}_{15} & {b}_{16} & {b}_{17} & {b}_{18} & {b}_{19} & {b}_{20} & P \\ {b}_{21} & {b}_{22} & {b}_{23} & {b}_{24} & {b}_{25} & {b}_{26} & {b}_{27} & {b}_{28} & {b}_{29} & {b}_{30} & {b}_{31} & {b}_{32}\end{matrix} ] , \\ {E}_{24 D - {RHP}_{uu}} = [ \begin{matrix}{b}_{1} & {b}_{1} & {b}_{1} & {b}_{1} & {b}_{1} & {b}_{1} & {b}_{1} & {b}_{1} & {b}_{1} & {b}_{1} & {b}_{1} & {b}_{1} \\ {b}_{2} & {b}_{3} & {b}_{4} & {b}_{5} & {b}_{6} & {b}_{7} & {b}_{8} & {b}_{9} & c & c & c & c \\ {b}_{10} & {b}_{11} & {b}_{12} & {b}_{13} & {b}_{14} & {b}_{15} & {b}_{16} & {b}_{17} & {b}_{18} & {b}_{19} & {b}_{20} & P \\ {b}_{21} & {b}_{22} & {b}_{23} & {b}_{24} & {b}_{25} & {b}_{26} & {b}_{27} & {b}_{28} & {b}_{29} & {b}_{30} & {b}_{31} & {b}_{32} \\ {b}_{31} & {b}_{32} & {b}_{33} & {b}_{34} & {b}_{35} & {b}_{36} & {b}_{37} & {b}_{38} & {b}_{39} & {b}_{70} & {b}_{41} & {b}_{42}\end{matrix} ] \\ {E}_{24 D - {RHP}_{uuu}} = [ \begin{matrix}{b}_{1} & {b}_{1} & {b}_{1} & {b}_{1} & {b}_{1} & {b}_{1} & {b}_{1} & {b}_{1} & {b}_{1} & {b}_{1} & {b}_{1} & {b}_{1} \\ {b}_{2} & {b}_{3} & {b}_{4} & {b}_{5} & {b}_{6} & {b}_{7} & {b}_{8} & {b}_{9} & c & c & c & c \\ {b}_{10} & {b}_{11} & {b}_{12} & {b}_{13} & {b}_{14} & {b}_{15} & {b}_{16} & {b}_{17} & {b}_{18} & {b}_{19} & {b}_{20} & P \\ {b}_{21} & {b}_{22} & {b}_{23} & {b}_{24} & {b}_{25} & {b}_{26} & {b}_{27} & {b}_{28} & {b}_{29} & {b}_{30} & {b}_{31} & {b}_{32} \\ {b}_{33} & {b}_{34} & {b}_{35} & {b}_{36} & {b}_{37} & {b}_{38} & {b}_{39} & {b}_{40} & {b}_{41} & {b}_{42} & {b}_{43} & {b}_{44} \\ {b}_{45} & {b}_{45} & {b}_{46} & {b}_{47} & {b}_{48} & {b}_{49} & {b}_{50} & {b}_{51} & {b}_{52} & {b}_{53} & {b}_{54} & {b}_{55}\end{matrix} ]$$

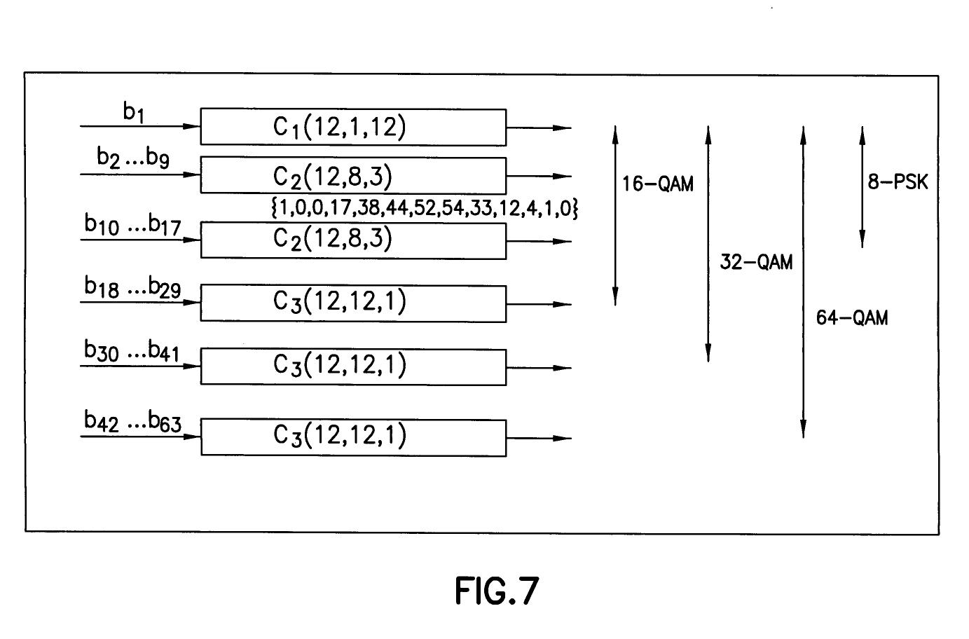

With reference to FIG. 7, there is illustrated the 24D-RHHuuu scheme. As in the 24D-RHPuuu scheme described above, one can change the subcarrier modulation as 8PSK/16QAM/32QAM/64QAM depending on the number of uncoded bits. The corresponding rate and bandwidth efficiencies are 0.4722/0.6042/0.6833/0.7361 and 1.4166/2.4166/3.4166/4.4166 [bits/symbol/Hz].

In these 24D schemes, one can divide the total available subcarriers into a set of 12 subcarriers according to the 24D subcarrier modulation. In some cases, one can control the number of available subcarriers to meet the required coding rate. To address these cases, exemplary and non-limiting embodiments of the invention provide multidimensional ML-BCM schemes as follows.

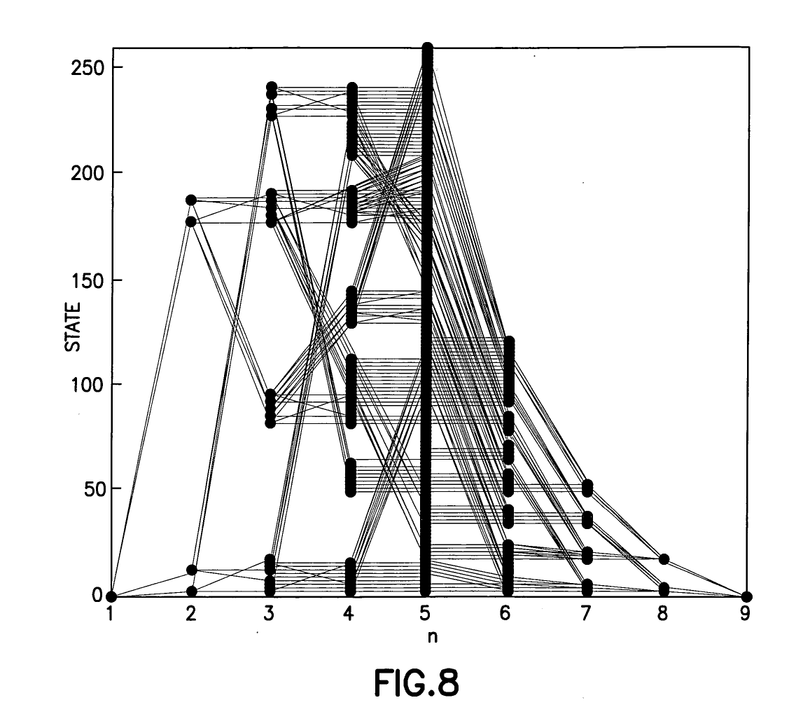

In the 16D-RHHuuu structure, there are generated eight complex-valued symbols and there is equivalently applied the same subcarrier modulation over eight subcarriers. For a component code, one can use a repetition code C₁(8,1,8), an extended Hamming code C₂(8,4,4), and three uncoded bits C₃(8,8,1). The same signal constellation as in the previous structures, described above, may be used. With reference to FIG. 8, there is illustrated the corresponding trellis diagram for an exemplary embodiment of a 16D RHHuuu scheme. The total number of states is 256. The number of parallel branches is 1/2/3/4 in proportion to the modulation. The coding rate is 0.375/0.5313/0.625/0.6875. The bandwidth efficiency is 1.1125/2.125/3.125/4.125 [bit/symbols/Hz]. With this structure, one can use a set of eight subcarriers. The encoder matrices are given by

$${E}_{16 D - RHH} = [ \begin{matrix}{b}_{1} & {b}_{1} & {b}_{1} & {b}_{1} & {b}_{1} & {b}_{1} & {b}_{1} & {b}_{1} \\ {b}_{2} & {b}_{3} & {b}_{4} & {b}_{5} & c & c & c & c \\ {b}_{6} & {b}_{7} & {b}_{8} & {b}_{9} & c & c & c & c\end{matrix} ] , \\ {E}_{16 D - {RHH}_{uuu}} = [ \begin{matrix}{b}_{1} & {b}_{1} & {b}_{1} & {b}_{1} & {b}_{1} & {b}_{1} & {b}_{1} & {b}_{1} \\ {b}_{2} & {b}_{3} & {b}_{4} & {b}_{5} & c & c & c & c \\ {b}_{6} & {b}_{7} & {b}_{8} & {b}_{9} & c & c & c & c \\ {b}_{10} & {b}_{11} & {b}_{12} & {b}_{13} & {b}_{14} & {b}_{15} & {b}_{16} & {b}_{17} \\ {b}_{18} & {b}_{19} & {b}_{20} & {b}_{21} & {b}_{22} & {b}_{23} & {b}_{24} & {b}_{25} \\ {b}_{26} & {b}_{27} & {b}_{28} & {b}_{29} & {b}_{30} & {b}_{31} & {b}_{32} & {b}_{33}\end{matrix} ] .$$

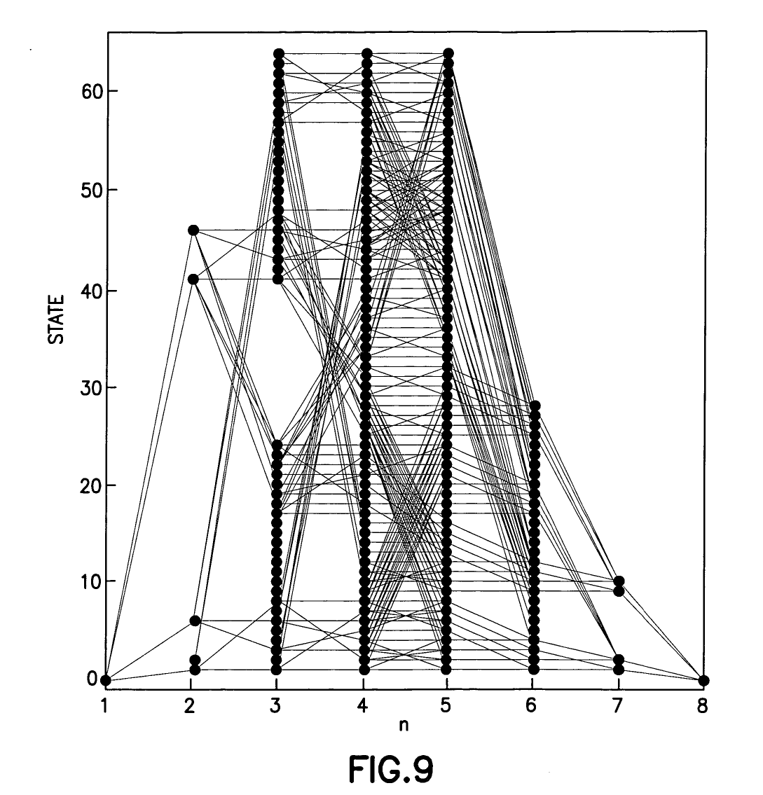

The component codes for a 14-D ML-BCM (14D-RHHHuuu) according to the exemplary embodiments of the invention are a repetition code C₁(7,1,7), extended Hamming code C₂(7,4,3), and the uncoded bits C₄(7,7,1). The total number of states is 64. The coding rate is 0.3333/0.5714/0.6571/0.7143. The bandwidth efficiency is 1.0/2.0/3.0/4.0 [bit/symbols/Hz]. This exemplary structure allows one to use a set of seven subcarriers. With reference to FIG. 9, there is illustrated half of a trellis diagram for an exemplary embodiment of a 14-D RHHuuu scheme.

An exemplary and non-limiting embodiment of a detection algorithm for the ML-BCMs described above is as follows. Let G be the generator matrix for the linear block code. For the parity check matrix, H, it is true that
HGd≡Hr−0,
where r is the transmitted input sequence. This property leads to the observation that the parity check matrix can detect any errors between the transmitted sequences and the detected sequences, H\tilde{r}≠0, where \tilde{r}=aGd+z, is the amplitude distortion coming from fading, and z is additive white Gaussian noise. One may use the maximum likelihood (ML) decoder using a trellis, or an alternative algorithm, such as a multistage decoding algorithm.

Using the property of the parity-check matrices, denoted by Hᵢ,i=1,2, . . . , L, one can construct the trellis diagram as described, for example, in “Design of trellis decoder for block-coded modulation schemes,” IEE proc. commun., vol. 147, pp. 1-7, February 2000 by M. A. Petronio and R. A. Carrasco.

In the trellis, the next state is obtained from the current state following equation:

$${S}_{n} ( l + 1 ) = {S}_{p} ( l ) + {\sum }_{i = 1}^{L} {α}_{i} {h}_{i , l + 1} ,$$

where L is the number of block codes, αε{0,1},h_{i,l+1}, is the (l+1)-th column vector of the parity check matrix Hᵢ, Sₙ(l+1)represents the destination state in the level of l+1, and Sₚ(l) represents the source state in the level of 1. The number of states for the i-th block code, denoted by (nᵢ,kᵢ), is 2⁽ⁿᵢ−kᵢ) Thus, the total number of states for the ML-BCM is

$$st = {\prod }_{i = 1}^{L} {2}^{{l}_{i}} , \\ {l}_{i} = \{ \begin{matrix}{n}_{i} - {k}_{i} , & for {k}_{i} > 1 , \\ 1 , & for {k}_{i} = 1.\end{matrix}$$

Let

$$b = {\sum }_{i = 1}^{L} ( {n}_{i} - {k}_{i} )$$

be the length of the state-vector, then h_{i,l+1}, should have brows. With this requirement, one needs to add additional rows to the parity-check matrices, such that a set of new parity-check matrices \check{H}ᵢ,i=1,2, . . . , L will have exactly brows with extra requirements:
The columns of \check{H}ᵢ must contain \check{H}ᵢ in its original form,
The matrix \check{H}ᵢ must be linearly independent except the corresponding parity matrix for uncoded bits.

These requirements can be satisfied by appending zero row vectors in Hᵢ εZ^{(n-k)×n}, such that \check{H}ᵢ is \check{H}ᵢ εZ^{b×n}. With the following systematic construction for \check{H}ᵢ, one can efficiently construct the trellis diagram for the ML-BCM with any combination of component codes.

$${∀}_{i = 1 , 2 , … , L} {\breve{H}}_{i} = [ \begin{matrix}{0}_{{l}_{i , 1} \times n} \\ {H}_{i} \\ {0}_{{l}_{. i , 2} \times n}\end{matrix} ] , {l}_{i , 1} = {\sum }_{l = 1}^{i - 1} ( {n}_{l} - {k}_{l} ) , {l}_{i , 2} = {\sum }_{l = i + 1}^{L} ( {n}_{l} - {k}_{l} ) .$$

To demonstrate the above approach, there is considered a ML-BCM that includes a C₁(7,4,3) Hamming code, a C₂(7,6,2)Parity code, and a C₃(7,7,1) uncoded code. The parity matrix is respectively given by

$${H}_{1} = [ \begin{matrix}1 & 1 & 1 & 0 & 1 & 0 & 0 \\ 0 & 1 & 1 & 1 & 0 & 1 & 0 \\ 1 & 1 & 0 & 1 & 0 & 0 & 1\end{matrix} ] , \\ {H}_{2} = [ \begin{matrix}1 & 1 & 1 & 1 & 1 & 1 & 1\end{matrix} ] , \\ {H}_{3} = [ \begin{matrix}0 & 0 & 0 & 0 & 0 & 0 & 0\end{matrix} ] .$$

Following the procedure to generate \check{H}ᵢ,

$$b ≡ {\sum }_{i = 1}^{3} ( {n}_{i} - {k}_{i} ) = 4 ,$$

one
can generate the following new parity-matrices:

$${\breve{H}}_{1} = [ \begin{matrix}1 & 1 & 1 & 0 & 1 & 0 & 0 \\ 0 & 1 & 1 & 1 & 0 & 1 & 0 \\ 1 & 1 & 0 & 1 & 0 & 0 & 1 \\ 0 & 0 & 0 & 0 & 0 & 0 & 0\end{matrix} ] , {\breve{H}}_{2} = [ \begin{matrix}0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , \\ {\breve{H}}_{3} = [ \begin{matrix}0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0\end{matrix} ] .$$

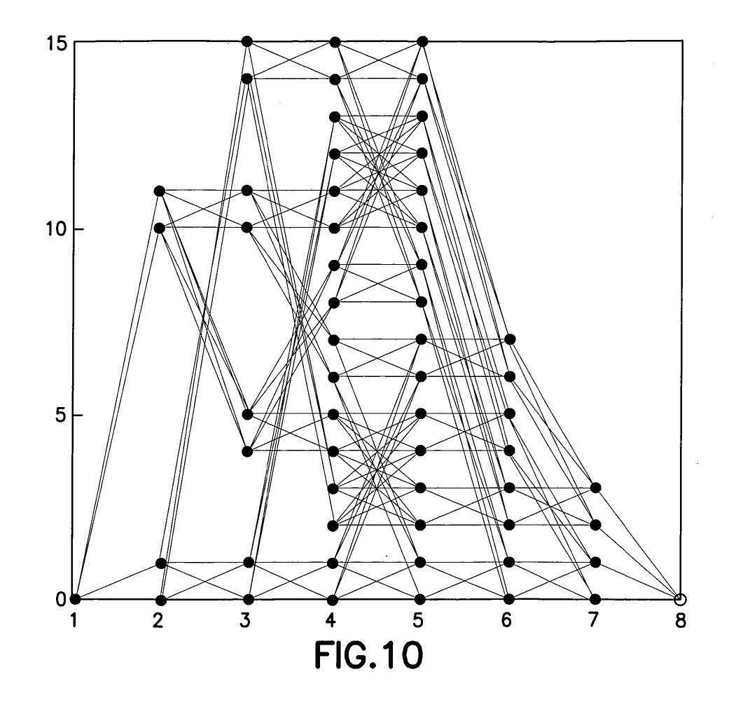

Note that all new parity-matrices have four rows, and that the new parity matrix for the uncoded code is a zero matrix. The trellis diagram for this exemplary ML-BCM is illustrated in FIG. 10. It should further be noted that the Trellis diagrams of FIGS. 6, 8, and 9 were generated using the procedure explained above.

There now follows simulation results for various ML-BCMs according to exemplary and non-limiting embodiments of the invention described above. The simulation parameters are:
Nt=1,Nᵣ=1.
Assume an exact knowledge of a channel information.
Use the same modulation for all subcarriers, K=64.
Packet size is 1 OFDM symbol.

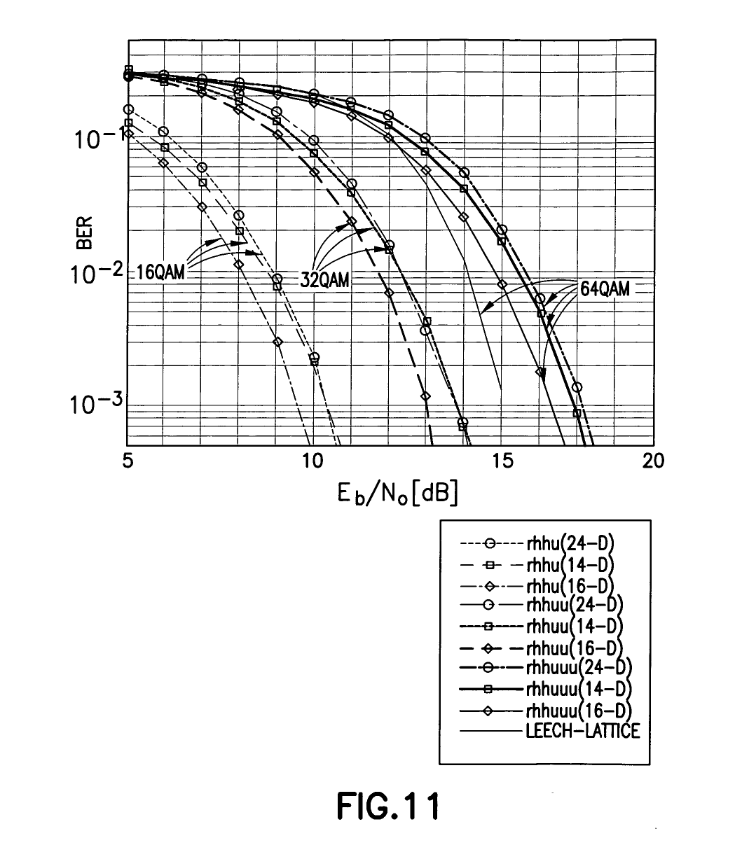

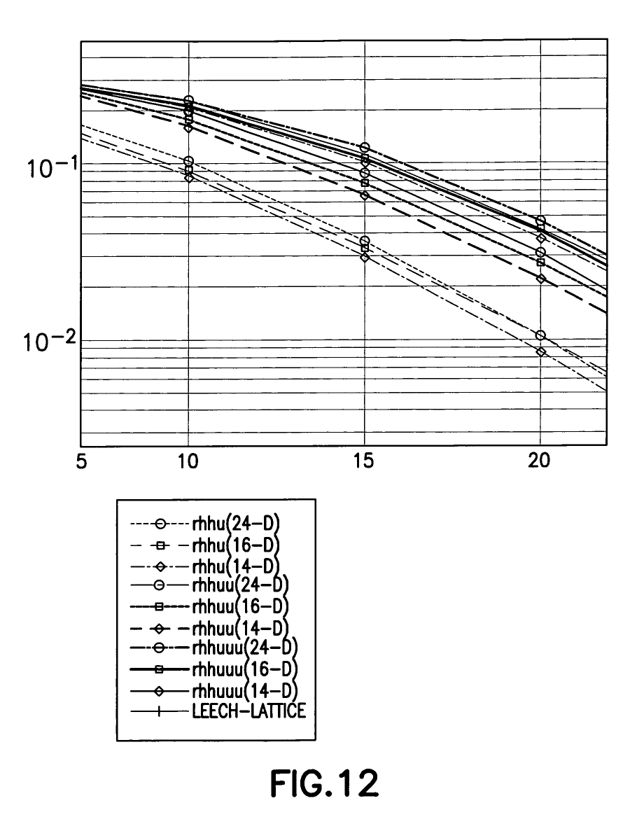

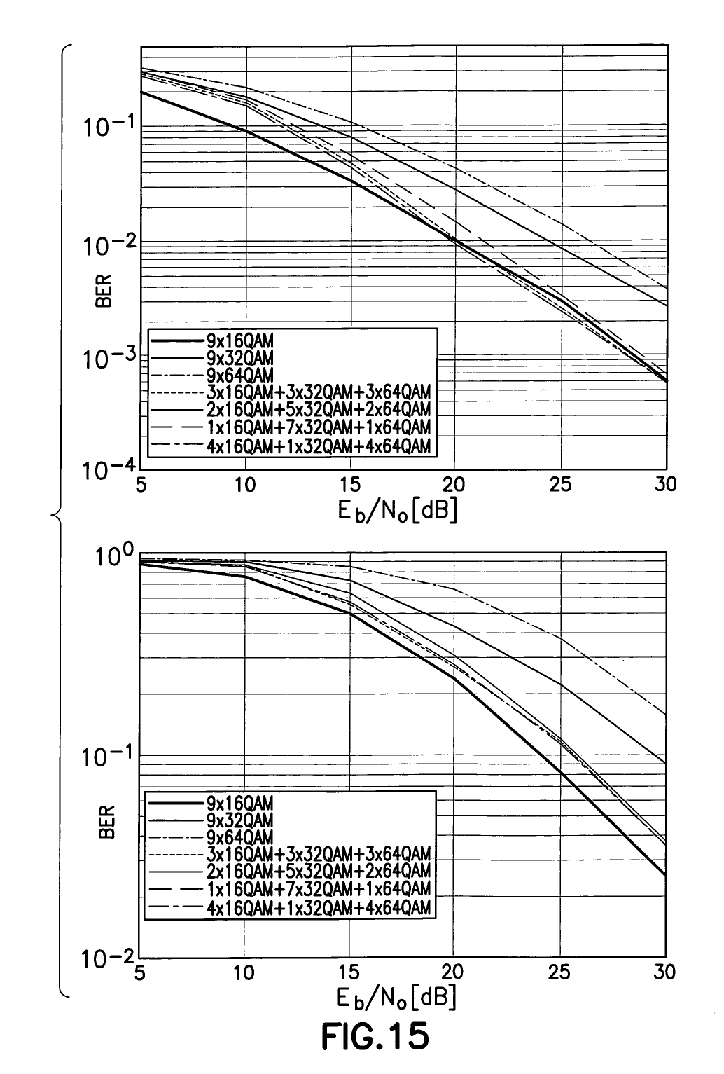

With reference to FIG. 11, there is illustrated the bit error rate (BER) performance over AWGN channel for 24D/16D/14D ML-BCMs according to exemplary embodiments of the invention. As may be expected, the higher modulation has worse performance than the lower modulation. Also, when comparing 16D RHHuuu to 14D RHHuuu, 16D RHHuuu generally outperforms 14D RHHuuu. With reference to FIG. 15, there is illustrated the BER/PER for adaptive 14D RHHuuu schemes according to exemplary embodiments of the invention for a 5-tap fading channel. With reference to FIG. 12, there is illustrated the BER performance for 24D/16D/14D ML-BCMs according to exemplary embodiments of the invention. As FIG. 12 suggests, as in the AWGN case, one obtains the same trend in portion to the modulation and the ML-BCM scheme. However, the gain between the modulation is reduced in the fading case.

With an exact knowledge of the channel information at the transmitter, one can optimally, or nearly optimally, adapt the coding rate and the power given the average power constraint. In the conventional approach of adaptive modulation, each subcarrier is modulated with a different modulation scheme in accordance with its power strength. The allocation of bits and transmission power to the subcarriers is done using the bit loading algorithms. In addition, the considered channel equalizer is the zero-forcing equalizer, so that there will be a noise enhancement depending on the estimated channel magnitude.

In accordance with the non-limiting and exemplary embodiments of the invention, one can adaptively apply the ML-BCM for each subcarrier with an available channel information at the transmitter.

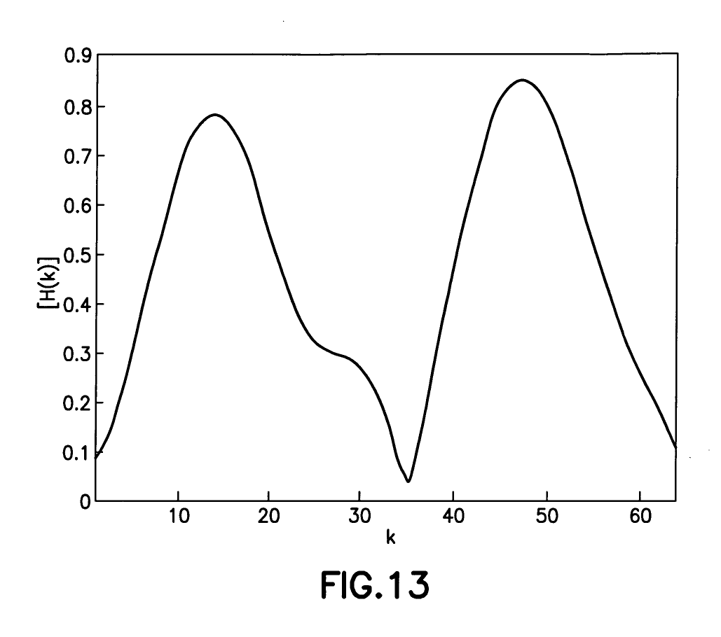

With reference to FIG. 13, there is illustrated a typical frequency response to of an OFDM system to an exemplary embodiment of a ML-BCM structure. There is first applied a grouping method in terms of the modulation symbol interval. For example, when using the 24D RHHuuu scheme, one needs to provide a set of 12 subcarriers, while a set of seven subcarriers is required for the 14D RHHuuu scheme. With a given coding rate, the next step is to find a combination of the proposed ML-BCM schemes that will provide the maximum coding rate subject to the power constraint. For this purpose, the table specifying the combination method and its coding rate is given in Table 1. Note that this table gives only a part of all the combinations over 64 subcarriers.

TABLE 1
An adaptive combination method for 64
subcarriers.

| | 14D RHHuuu | | 16D RHHuuu | | 24D RHHuuu | |
|---|---|---|---|---|---|---|
| 16QAM | 9 * 16QAM | R = 0.5714 | 8 * 16QAM | R = 0.5213 | 5 * 16QAM | R = 0.6042 |
| 32QAM | 9 * 32QAM | R = 0.6571 | 8 * 32QAM | R = 0.625 | 5 * 32QAM | R = 0.6833 |
| 64QAM | 6 * 64QAM | R = 0.7143 | 8 * 64QAM | R = 0.6875 | 5 * 64QAM | R = 0.7361 |
| Adaptive | 3 * 16QAM + | R = 0.6571 | 2 * 16QAM + | R = 0.625 | 1 * 16QAM + | R = 0.6833 |
| Scheme | 3 * 32QAM + | | 4 * 32QAM + | | 3 * 32QAM + | |
| | 3 * 64QAM | | 2 * 64QAM | | 1 * 64QAM | |
| | 2 * 16QAM + | | 3 * 16QAM + | | 2 * 16QAM + | |
| | 5 * 32QAM + | | 2 * 32QAM + | | 1 * 32QAM + | |
| | 2 * 64QAM | | 2 * 64QAM | | 2 * 16QAM | |
| | 1 * 16QAM + | | | | | |
| | 7 * 32QAM + | | | | | |
| | 1 * 64QAM | | | | | |
| | 4 * 16QAM + | | | | | |
| | 1 * 32QAM + | | | | | |
| | 4 * 64QAM | | | | | |

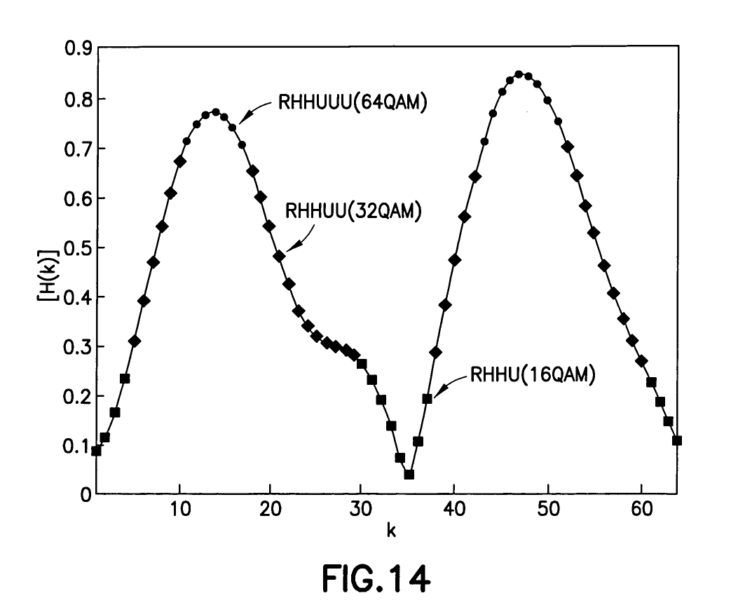

For the frequency response illustrated in FIG. 13, FIG. 14 illustrates one adaptive scheme for the 16D RHHuuu, called the 2-4-2 16D RHHuuu. Since the lower modulation (16QAM) has a better performance, it is applied it to the weaker subcarriers, while the higher modulation, 64QAM is applied to the stronger subcarriers. Using this approach, one can improve the performance compared with an adaptive ML-BCM scheme at the same coding rate.

FIG. 15 makes clear that over 5-tap fading channel, 3-3-3, 2-5-2, 4-1-4 14D RHHuuu schemes work better than the original nonadaptive scheme at the same coding rate. At 10⁻² bit error rate (BER), they can achieve 5 [dB] gain. The number of subcarriers is 64 and the packet is composed of one OFDM symbol. The BER performance improvement is evident. For the same simulation parameters, there is also shown the packet error rate (PER) for adaptive ML-BCMs. For 10⁻² BER, 3 [dB] gain in terms of PER can be achieved.

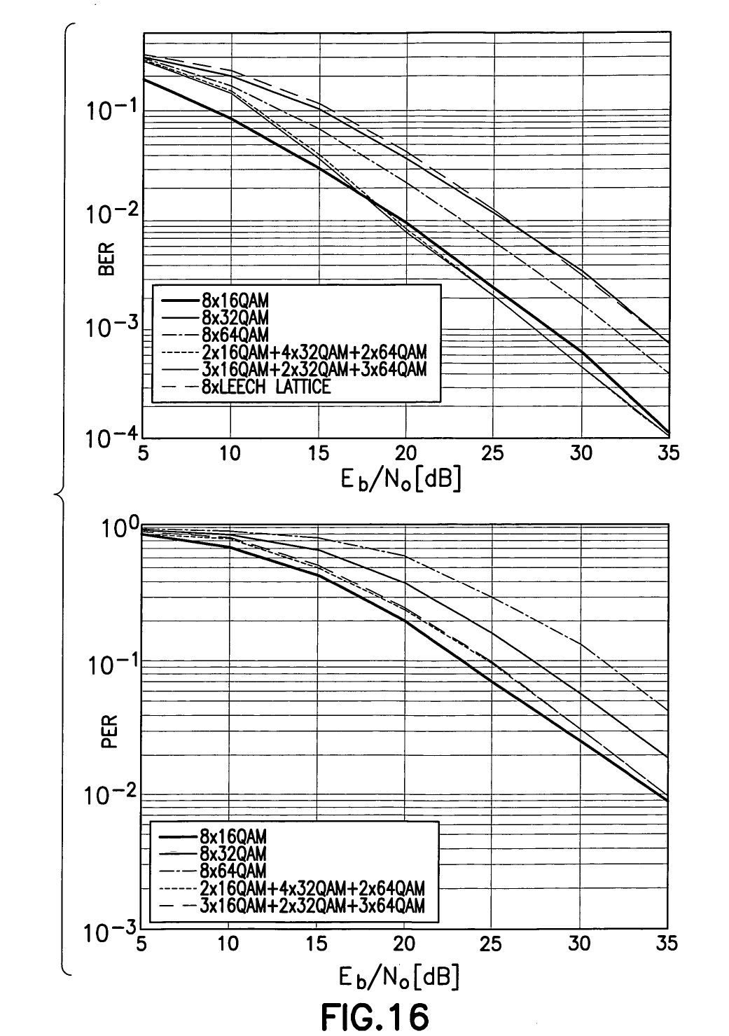

For a 16DRHHuuu scheme, this structure has a similar tendency to improve the BER and the PER performances as illustrated in FIG. 16.

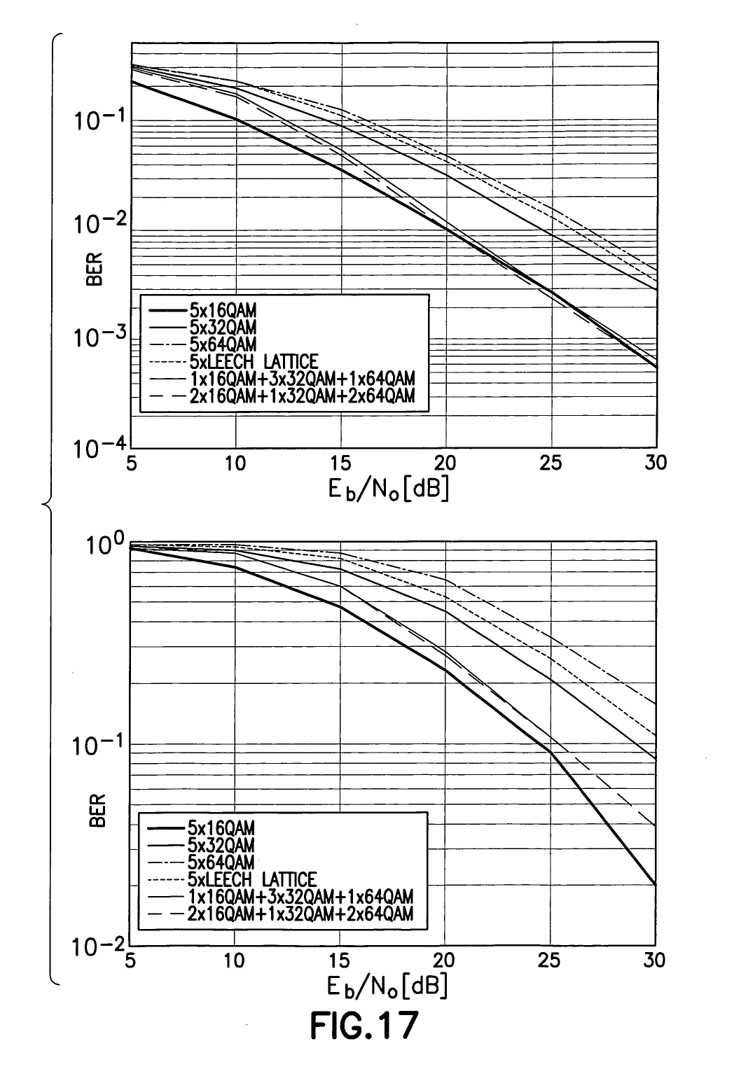

With reference to FIG. 17, there is illustrated the BER/PER for an exemplary embodiment of a 24D RHHuuu scheme over a 5-tap fading channel. As is evident, regardless of the dimension, one can obtain a relative performance improvement with the use of the exemplary embodiments of the invention.

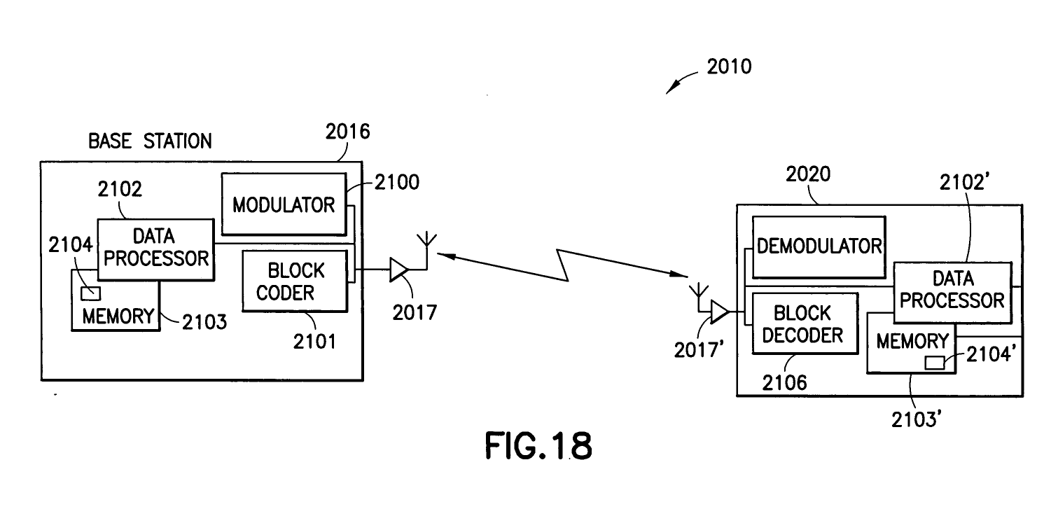

FIG. 18 is a block diagram of apparatus suitable for implementing the exemplary and non-limiting embodiments of the invention. A wireless communication system 2010 includes a network element 2016, such as a base station, having at least one antenna 2017, for bidirectional communication with a user equipment (UE) 2020 having at least one antenna 2017′. The network element 2016 includes a modulator element 2100 and a block coder 2101 for modulating and encoding, respectively, input signals. Both the modulator element 2100 and the block coder 2101 can be implemented in hardware, software, or a combination of the two. Network element 2016 further includes a data processor 2102 that in turn includes or is coupled to a memory 2103. The memory 2103 stores data and operating programs, including one or more programs 2104 the execution of which implements the disclosed exemplary embodiments of the invention, including, but not limited to, the modulation and coding functionality described above.

The UE 2020 includes a demodulator element 2105 and a block decoder 2106 for demodulating and decoding, respectively, incoming signals. UE 2020 further includes a data processor 2102′ that in turn includes or is coupled to a memory 2103. The memory 2103 stores data and operating programs, including one or more programs 2104′ the execution of which implements the disclosed exemplary embodiments of the invention, including, but not limited to, the demodulation and decoding functionality described above.

In general, the various embodiments of the UE 2020 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

As noted above, certain of the exemplary embodiments of the invention may be implemented by computer software executable by the data processor 2102 of the network element 2016, and/or by the data processor 2102′ of the UE 2020, and/or by dedicated hardware, or by a combination of software and hardware.

The memories 2103 and 2103′ may be of any type suitable to the local technical environment and may be implemented using any suitable data storage technology, such as semiconductor-based memory devices, magnetic memory devices and systems, optical memory devices and systems, fixed memory and removable memory. The data processors 2102 and 2102′ may be of any type suitable to the local technical environment, and may include one or more of general purpose computers, special purpose computers, microprocessors, digital signal processors (DSPs) and processors based on a multi-core processor architecture, as non-limiting examples.

Based on the foregoing discussion it can be appreciated that in one non-limiting and exemplary embodiment of the invention there is provided an apparatus, method and a computer program product for sending a message over a wireless channel formed of a transmitter for sending data on a set of N subcarriers, an input element for receiving a stream of input data and grouping the data in N groups, a modulation element for modulating the N subcarriers with the N groups of data. In an exemplary embodiment, the N subcarriers are grouped in M subgroups of approximately equal power at the receiver, and each of the M subgroups is modulated with a modulation such that the Hamming distance of the weakest subgroup is greater than corresponding Hamming distances of other subgroups. Furthermore, the modulation element may apply a block code formed from a repetition code, a Hamming code and a set of uncoded bits. In an exemplary embodiment, the subgroups are chosen such that the product distance of each subgroup is substantially equal. In addition, the system may further include an element for changing the modulation element to apply a different set of modulations to the subgroups in response to changing channel conditions. The modulation element may have the ability to change the value of M.

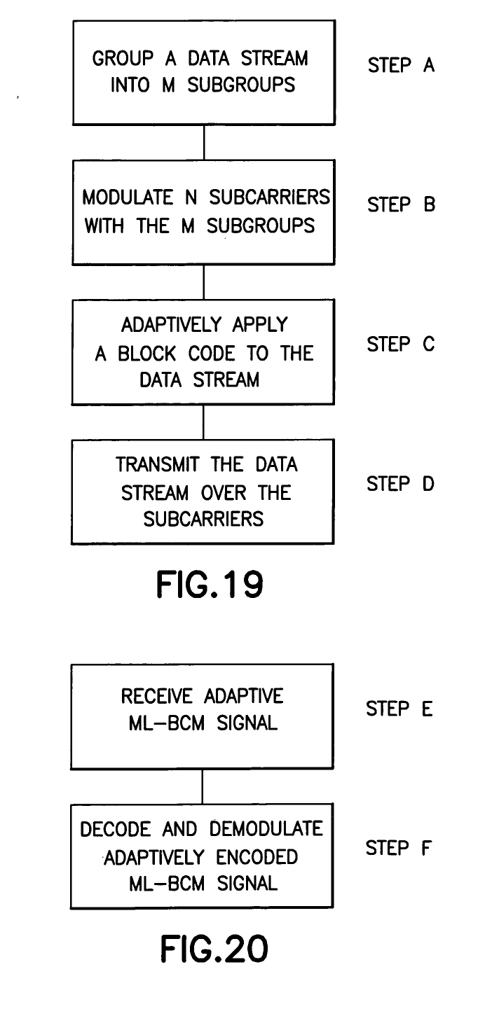

With reference to FIG. 19, there is illustrated a flow chart of an exemplary and non-limiting embodiment of the invention. At step A, a data stream is grouped into M subgroups. At step B, N subcarriers are modulated with the M subgroups. At step C, a block code is adaptively applied to the data stream based upon a channel characteristic of each of the subcarriers. At step D, the data stream is transmitted over the subcarriers.

With reference to FIG. 20, there is illustrated a flow chart of an exemplary and non-limiting embodiment of the invention. At step E, a receiver receives a signal that has been encoded by adaptively applying a block code to the data stream based upon a channel characteristic of each of a number of subcarriers and modulated according to exemplary embodiments of the invention. At step F, the signal is demodulated and decoded.

The use of the exemplary embodiments of the invention involves providing a transmitter/receiver system having the capability of processing a number of subcarriers. Not all subcarriers will be used all the time (e.g. if 24 carriers are available and the modulation chosen only needs 16, then 8 will be unused). Exemplary embodiments of the invention further involve receiving an input bit stream and grouping it into blocks. When applying different block code modulation schemes to the data depending on which subcarrier is being modulated, one exemplary criterion employed for choosing the modulation is that the product distance is made as uniform as practical (referred to as being substantially equal). Exemplary embodiments of the invention may further involve testing the channel quality at the receiver periodically and changing the modulation scheme to apply better modulation (a greater product distance and thus lower error rate) to carriers having less good channel quality; and applying modulation with a smaller product distance to carriers having a lower error rate.

For a single antenna at the transmitter and the receiver, there is first provided the ML-BCMs for different dimensions. Based on these schemes, there is further provided adaptive ML-BCMs, which adaptively apply the subcarrier modulation determined by an estimated power strength for subcarriers. The simulation results show that the exemplary embodiments can efficiently improve the performance in all proposed multi-dimensional ML-BCMs.

Note that while the exemplary embodiments have been described in the context of trellis based detectors, it is within the scope of these exemplary embodiments to use a simpler detector such as one based on a suboptimal detection approach. This may be especially advantageous when extending the exemplary embodiments of the invention to MIMO-OFDM and other types of multiantenna systems.

It is there evident that the exemplary and non-limiting embodiments disclosed above meet two design criteria including, but not limited to, 1) providing the capability of handling of multiple coding rates, and 2) providing the capability of handling a different number of available subcarriers. For these design criterion, there has been disclosed a multidimensional ML-BCM structures composed of the repetition code, a Hamming code, and uncoded bits. Since the Euclidean distance at the top level is shortest, the most powerful repetition code is used to increase the product distance. The same length of a block code is used for the second and the third levels. A Hamming code is extended or shortened to meet the required dimensionality. The top three levels determine the signal point in the signal constellation for 8-PSK subcarrier modulation. As a result, the coding rate and the subcarrier modulation are mainly determined by the number of uncoded bits. Using a linear and simple block code for a component code, one can reduce the hardware requirement.

As noted above, with an exact knowledge of the channel information at the transmitter, one can optimally adapt the coding rate. In exemplary embodiments of the invention, one first categorizes all available subcarriers in terms of the power strength into several groups, where each group uses a different type of the ML-BCM. This is different from a general adaptive scheme, wherein one adaptively applies a modulation to each subcarrier. For example, when the dimensionality is 16 and one is required to use 64 subcarriers, one needs to divide all available 64 subcarriers into a set of 8 subcarriers to use the 16-dimensional ML-BCM. For a typical frequency channel response, one assigns 16-QAMs to 16 weaker subcarriers, 32-QAMs to 24 medium strength subcarriers, and 64-QAMs to 16 stronger subcarriers. In the present context and as used herein, “weaker” and “stronger” refer to the relative strength of the subcarriers where the strength is defined as the power of a channel at each frequency bin. By using this proposed adaptive grouping scheme, one can improve performance.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the exemplary embodiments of the invention are not limited thereto. While various aspects of the exemplary embodiments of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of the exemplary embodiments of the invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
grouping a data stream into a first plurality of subgroups;
modulating a plurality of subcarriers with said first plurality of subgroups;
adaptively applying a block code to said data stream comprising a repetition code, a Hamming code, and a plurality of uncoded bits based upon a channel characteristic of each of said plurality of subcarriers; and
transmitting said data stream on said plurality of subcarriers.

2. The method of claim 1 wherein a number of said plurality of subcarriers comprises one of fourteen, sixteen, and twenty-four.

3. The method of claim 1 wherein each of said plurality of subgroups have an approximately equal power at a receiver.

4. The method of claim 1 further comprising modulating each of the plurality of subgroups such that a Hamming distance of a weakest one of said plurality of subgroups is greater than a Hamming distance of any other one of said plurality of subgroups.

5. The method of claim 1 wherein a product distance of each of said plurality of subgroups is substantially equal.

6. The method of claim 1 comprising applying a modulation to said plurality of subgroups in response to a change in a condition of a channel.

7. The method of claim 1 wherein modulating comprises changing a number of said first plurality of subgroups.

8. The method of claim 1 wherein modulating comprises adaptively modulating said plurality of subcarriers based upon an estimated power strength of said plurality of subcarriers.

9. The method of claim 1 comprising changing a code rate for at least one of said plurality of subcarriers based upon a signal gain.

10. A program of machine-readable instructions, tangibly embodied on an information bearing medium and executable by a digital data processor, to perform actions comprising:
grouping a data stream into a first plurality of subgroups;
modulating a plurality of subcarriers with said first plurality of subgroups;
adaptively applying a block code to said data stream comprising a repetition code, a Hamming code, and a plurality of uncoded bits based upon a channel characteristic of each of said plurality of subcarriers; and
transmitting said data stream on said plurality of subcarriers.

11. The program of claim 10 wherein a number of said plurality of subcarriers comprises one of fourteen, sixteen, and twenty-four.

12. The program of claim 10 wherein each of said plurality of subgroups have an approximately equal power at a receiver.

13. The program of claim 10 further comprising modulating each of the plurality of subgroups such that a Hamming distance of a weakest one of said plurality of subgroups is greater than a Hamming distance of any other one of said plurality of subgroups.

14. The program of claim 10 wherein a product distance of each of said plurality of subgroups is substantially equal.

15. The program of claim 10 comprising applying a modulation to said plurality of subgroups in response to a change in a condition of a channel.

16. The program of claim 10 wherein modulating comprises changing a number of said first plurality of subgroups.

17. The program of claim 10 wherein modulating comprises adaptively modulating said plurality of subcarriers based upon an estimated power strength of said plurality of subcarriers.

18. The program of claim 10 comprising changing a code rate for at least one of said plurality of subcarriers based upon a signal gain.

19. A network element comprising:
a transmitter;
a processor coupled to the transmitter; and
a memory coupled to the processor for storing a set of instructions, executable by the processor, for grouping a data stream into a first plurality of subgroups;
modulating a plurality of subcarriers with said first plurality of subgroups;
adaptively applying a block code to said data stream comprising a repetition code, a Hamming code, and a plurality of uncoded bits based upon a channel characteristic of each of said plurality of subcarriers; and
transmitting said data stream on said plurality of subcarriers via said transmitter.

20. The network element of claim 19 wherein a number of said plurality of subcarriers comprises one of fourteen, sixteen, and twenty-four.

21. The network element of claim 19 wherein each of said plurality of subgroups have an approximately equal power at a receiver.

22. The network element of claim 19 further comprising modulating each of the plurality of subgroups such that a Hamming distance of a weakest one of said plurality of subgroups is greater than a Hamming distance of any other one of said plurality of subgroups.

23. The network element of claim 19 wherein a product distance of each of said plurality of subgroups is substantially equal.

24. The network element of claim 19 comprising applying a modulation to said plurality of subgroups in response to a change in a condition of a channel.

25. The network element of claim 19 wherein modulating comprises changing a number of said first plurality of subgroups.

26. The network element of claim 19 wherein modulating comprises adaptively modulating said plurality of subcarriers based upon an estimated power strength of said plurality of subcarriers.

27. The network element of claim 19 comprising changing a code rate for at least one of said plurality of subcarriers based upon a signal gain.

28. A method comprising:
receiving a data stream on a plurality of subcarriers modulated by a plurality of subgroups into which said data stream is grouped said data stream adaptively encoded with a block code comprising a repetition code, a Hamming code, and a plurality of uncoded bits based upon a channel characteristic of each of said plurality of subcarriers;
decoding said data stream; and
demodulating said data stream.

29. The method of claim 28 wherein a number of said plurality of subcarriers comprises one of fourteen, sixteen, and twenty-four.

30. The method of claim 28 wherein each of said plurality of subgroups have an approximately equal power at a receiver.

31. The method of claim 28 wherein a Hamming distance of a weakest one of said plurality of subgroups is greater than a Hamming distance of any other one of said plurality of subgroups.

32. The method of claim 28 wherein a product distance of each of said plurality of subgroups is substantially equal.

33. An encoder comprising:
means for receiving a data stream modulated by a plurality of subgroups into which said data stream is grouped; and
means for adaptively applying a block code to said data stream comprising a repetition code, a Hamming code, and a plurality of uncoded bits based upon a channel characteristic of each of a plurality of subcarriers.

34. The encoder of claim 33 wherein a number of said plurality of subcarriers comprises one of fourteen, sixteen, and twenty-four.

35. A decoder comprising:
means for receiving a data stream adaptively encoded with a block code comprising a repetition code, a Hamming code, and a plurality of uncoded bits based upon a channel characteristic of each of a plurality of subcarriers; and
means for decoding said data stream.

36. The decoder of claim 35 wherein a number of said plurality of subcarriers comprises one of fourteen, sixteen, and twenty-four.

37. A user equipment comprising:
a receiver;
a processor coupled to the receiver; and
a memory coupled to the processor for storing a set of instructions, executable by the processor, for receiving a data stream modulated by a plurality of subgroups into which said data stream is grouped said data stream adaptively encoded with a block code comprising a repetition code, a Hamming code, and a plurality of uncoded bits based upon a channel characteristic of each of a plurality of subcarriers, decoding said data stream, and demodulating said data stream.

38. A system comprising:
a network element comprising:
a transmitter;
a processor coupled to the transmitter; and
a memory coupled to the processor for storing a set of instructions, executable by the processor, for grouping a data stream into a first plurality of subgroups;
modulating a plurality of subcarriers with said first plurality of subgroups;
adaptively applying a block code to said data stream comprising a repetition code, a Hamming code, and a plurality of uncoded bits based upon a channel characteristic of each of said plurality of subcarriers; and
transmitting said data stream on said plurality of subcarriers via said transmitter; and
a user equipment in communication with said network element comprising:
a receiver;
a processor coupled to the receiver; and
a memory coupled to the processor for storing a set of instructions, executable by the processor, for receiving said data stream, decoding said data stream, and demodulating said data stream.

39. An integrated circuit comprising:
first circuitry having an input operable to receive a data stream and to group said data stream into a first plurality of subgroups;
second circuitry operable to modulate a plurality of subcarriers with said first plurality of subgroups; and
third circuitry operable to adaptively apply a block code to said data stream comprising a repetition code, a Hamming code, and a plurality of uncoded bits based upon a channel characteristic of each of said plurality of subcarriers.

40. The integrated circuit of claim 39 further comprising an output coupled to a radio frequency transmitter.
